(19) United States
(12) Patent Application Publication
(10) Pub. No.: US 2021/0351678 A1
(43) Pub. Date: Nov. 11, 2021

(54) Magnetic Motor

(71) Applicant: Hao Xu, Bedford (CA)

(72) Inventor: Hao Xu, Bedford (CA)

(21) Appl. No.: 16/776,578

(22) Filed: Jan. 30, 2020

(51) Int. Cl. H02K 21/12

(52) U.S. Cl. CPC H02K 21/12

(57) ABSTRACT

This Magnetic Motor is an appliance that uses magnetic force as energy source to bring about rotation movement, which can drive various machines such as generators and pumps.

This Magnetic Motor applies not only magnetic repulsion force, but also applies magnetic attraction force in order to get higher efficiency of magnetic energy.

Half of the magnets are electric ones, which make it easily to change pole directions from N/S to S/N and to control the strength of the force.

This Magnetic Motor is a kind of appliance that uses magnetic force as energy source to bring about rotation movement, which can drive various machines including generator.

Unlike a fossil-fuel motor, Magnetic Motor does not need air and has nothing to discharge, so no pollution will be co-produced either to the air or to the land during the energy transforming. Nor like a solar/wind motor, Magnetic Motor produces stable power output.

To use the magnetic energy in high efficiency, this Magnetic Motor applies not only magnetic repulsion force, but also magnetic attraction force at the aid of continually changed electric current, which can be from outside or from the Motor itself.

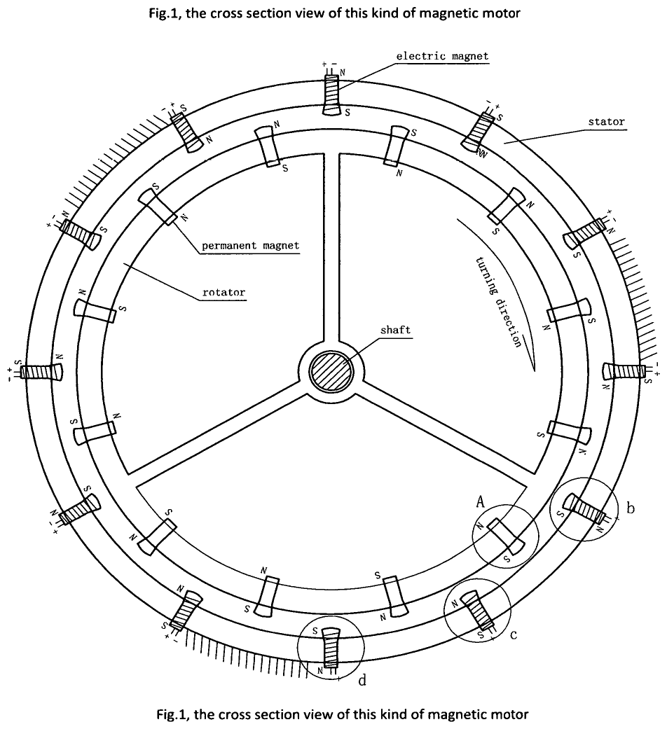

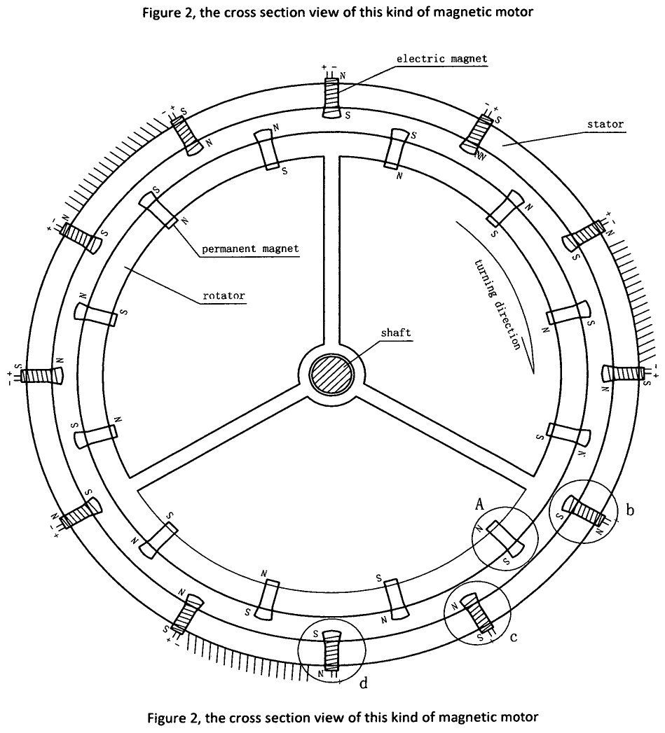

Attached FIG. 1 is the cross section view of this kind of magnetic motor, and this view is vertical to the rotator shaft of the magnetic motor.

This Magnetic Motor is consisted of two parts, stator and rotator, referring to FIG. 1. The stator is fixed frame and on it there are 12 electric magnets (may be more or less) arranged circularly with their poles either inwards or outwards different from their adjoin ones, and getting radial magnetic force.

On the rotator correspondingly are arranged 12 permanent magnets, also with their poles either inwards or outwards different from their adjoin ones and getting radial magnetic force. The rotator can rotate and output torque.

To get smooth power output, more pairs of the above stator and rotator may be arranged. For explaining simply here only one pair of that is assumed. Each magnet in the rotator is subjected to magnetic force in same way.

When magnet A in the rotator, referring FIG. 1, is turning between two magnets b and c in the stator, magnet A is induced both by b and c, repulsed from b while attracted by c, and both forces drive magnet A turning in same direction. When magnet A turns to the position around magnet c, automata shuts down the electric magnets and stop the magnetic forces from b and c to magnet A. At this moment this Motor is turning by its inertia as well as by other pair of stator and rotator. Automata turn on electric magnets again with changed direction of electric current just after magnet A passes magnet c, and then magnet A is repulsed from c and attracted by magnet d. So again, magnet A is turned continually in the same direction. In such way all permanent magnets in the rotator get their rotating force circularly in same direction.

The automata control the electric current direction as well as opening/closing time. By adjudging the time we can make the appliance more efficient.

Also where quick stop is needed, automata can make the direction of electric current in the opposite way from rotation to reduce spinning speed quickly without rubbing and heat.

A generator is normally connected to this Magnetic Motor to gain electricity, part of which can be supplied to this motor.

1. Both magnetic repulsion and attraction forces are applied synchronously in a magnetic motor to get rotating power.

2. Changing direction of electric current is applied in magnetic motor to change electric magnet's polarity.
